(19) United States
(12) Patent Application Publication
(10) Pub. No.: US 2008/0260370 A1
(43) Pub. Date: Oct. 23, 2008

(54) Optical System

(76) Inventors: Elke Zakel, Falkensee (DE); Ghassem Azdasht, Berlin (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/583,864

(22) PCT Filed: Dec. 22, 2004
(86) PCT No.: PCT/DE2004/002826

§ 371 Date: Jul. 3, 2008

(30) Foreign Application Priority Data
Dec. 23, 2003 (DE) 103 61 522.9

(51) Int. Cl. G03B 15/03

(52) U.S. Cl. 396/155

(57) ABSTRACT

Optical system (40) for observing multiple objects (61, 63) positioned distal from one another, having a camera unit (42) comprising a first prism unit (43) positioned on the optical axis (41) and/or in the beam path (47) of the camera unit for producing two partial beam paths (48, 49) as well as two object prism units (51, 52), each of which is situated in a partial beam path and assigned to an object.

The present invention relates to an optical system for observing multiple objects situated distal from one another having a camera unit comprising a first prism unit situated on the optical axis and/or in the beam path of the camera unit to generate two partial beam paths and two object prism units, each of which is situated in a partial beam path and assigned to an object.

In the production and particularly handling of microelectronic components, image processing systems which record position and/or quality information via a camera unit are frequently used, which are employed, depending on the degree of automation of the facility technology, for controlling further sequences. Due to the small dimensions of the microelectronic components, such as a chip, the corresponding dimensioning guidelines also apply for optical systems, which are to be able to be integrated into corresponding facility technology without interfering influence on the handling or manufacturing processes.

This is true in particular if differential observation of different surface points, such as raised contact metallizations of a chip, is to be performed using only one camera unit, or the relative orientation of the contact points of the microcomponents to one another, which is necessary for contacting multiple microelectronic components, is to be checked.

The present invention is thus based on the object of suggesting an optical system which allows differentiated observation of different surface points of microelectronic components, such as a chip, while simultaneously having the smallest possible space requirement for the optical system.

This object is achieved by an optical system having the features of Claim 1.

The optical system according to the present invention for observing multiple objects situated distal from one another using a camera unit comprises a first prism unit situated on the optical axis and/or in the beam path of the camera unit for producing two partial beam paths as well as two object prism units, each of which is situated in a partial beam path and assigned to an object.

Because of the optical system connected upstream from the camera unit, it is possible to observe multiple surface points of a microelectronic component, such as a chip, situated distal from one another using only one camera unit without multiple camera units to be handled in parallel to one another being necessary for this purpose, or, if only one camera unit is used, this unit having to be pivoted to observe multiple surface points. Instead, with appropriate distance setting between the object prism units, one may operate using a stationary static optical system and only one camera unit, so that there is also only a correspondingly smaller space requirement. In addition, the use of the object prism units opens up the advantage of being able to perform rapid adaptation to changing surface geometries through simple alteration of the relative distance of the object prism units from one another. Furthermore, the use of the object prism units offers the advantage that only very small masses must be moved during adaptation to the distance of the objects, so that a suitable apparatus adjustment unit may be implemented as correspondingly filigree and space-saving.

In an advantageous embodiment, an illumination unit is assigned to each object prism unit, so that adequate illumination of the objects and/or surface points to be observed is ensured independently of the environmental conditions via an illumination beam path conducted via the object prism units.

The illumination units may be implemented as especially space-saving if they are implemented as light-emitting semiconductor components, i.e., for example, as light-emitting diodes.

An exemplary embodiment of the optical system which is especially suitable for differentiated observation of surface points lying distal from one another of relatively oblong microelectronic components, such as an LED diode, has a construction in which the output beam paths of the object prism units run transversely to and in the same direction as the optical axis of the camera unit. Using this optical system it is thus possible to perform an observation using an optical system oriented below or above and essentially parallel to the plane of the surface topography of interest.

It is advantageous to situate the illumination units in such a way that the illumination beam paths implemented between the object prism units and the illumination units run transversely to the optical axis of the camera unit. It is possible in this way to implement the apparatus of the optical system so that the optical system has the lowest possible depth.

In any case, it has been shown to be advantageous for the construction of the optical system if the prism unit has two optical boundary faces situated perpendicular to one another and each angled at 45° to the optical axis of the camera unit.

Especially easy adaptation to a given topography is possible if the object prism units may have their distance changed.

In order to also allow uniform illumination of the objects independently of a specific distance between the object prism units and/or of a change of this distance, it has been shown to be advantageous if the illumination units may have their distance changed together with the object prism units.

In particular for the case in which the optical system is used for the relative orientation of contact metallizations in contacting procedures between multiple microelectronic components, an embodiment in which the output beam paths of the object prism units run transversely and in the opposite direction to the optical axis of the camera unit is advantageous.

If the illumination units are additionally situated in such a way that the illumination beam paths implemented between the object prism units and the illumination units run parallel to the plane of the optical axis of the camera unit, the flattest possible overall implementation of the optical system is made possible.

Use of the optical system even at extremely small distances between contact metallizations of two microelectronic components to be contacted with one another is possible if the prism unit has a first optical boundary face, angled by 45°, which is positioned on the optical axis of the camera unit, reflects a first partial beam path, and is transparent to a second partial beam path, a second optical boundary face situated perpendicular to the optical axis being positioned downstream from said first partial boundary face, to reflect the second partial beam path toward the first optical boundary face and reflect the second partial beam path in the direction of the second object.

In the following, preferred embodiments of the present invention are explained in greater detail on the basis of the drawing.

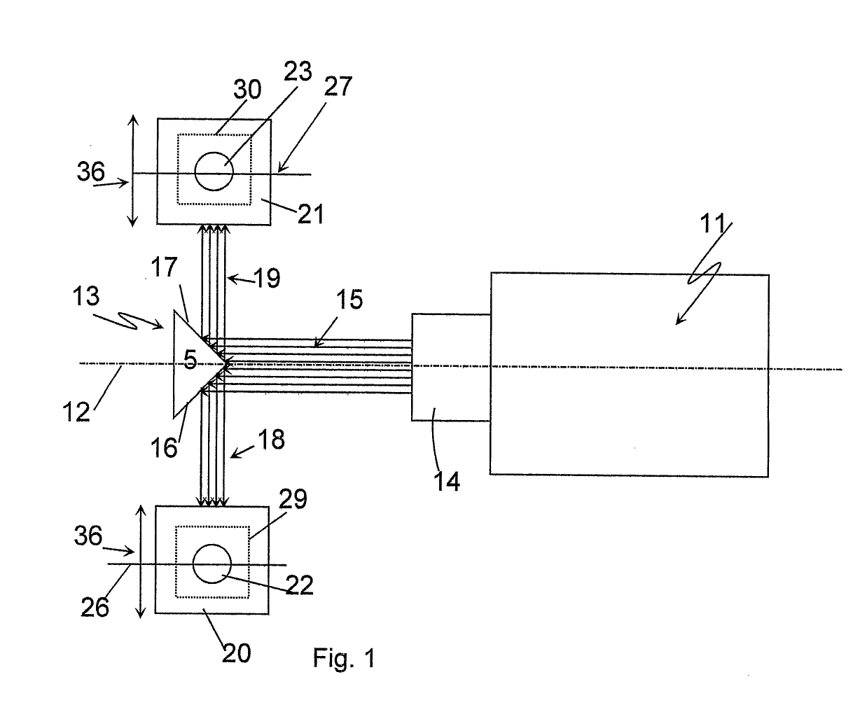

FIG. 1 shows a first optical system for observing two surface points of a surface situated distal to one another;

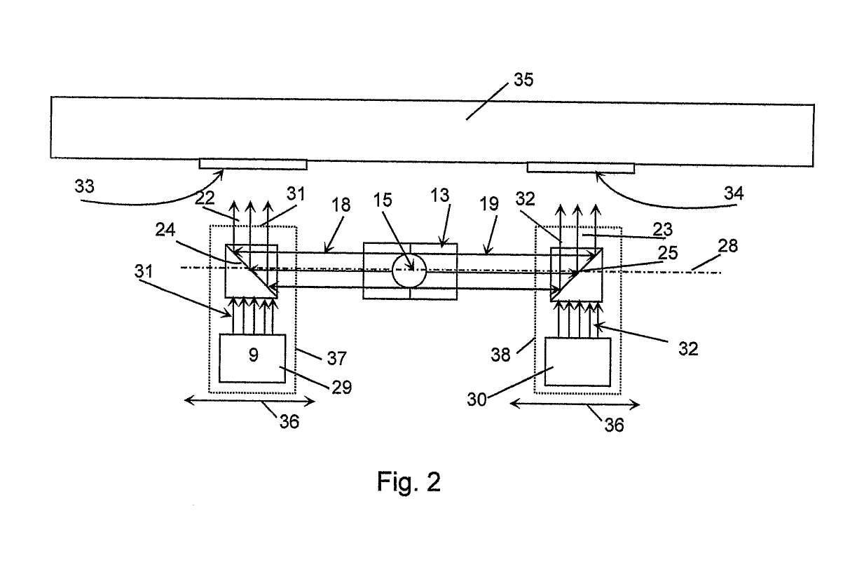

FIG. 2 shows a further view of the optical system shown in FIG. 1;

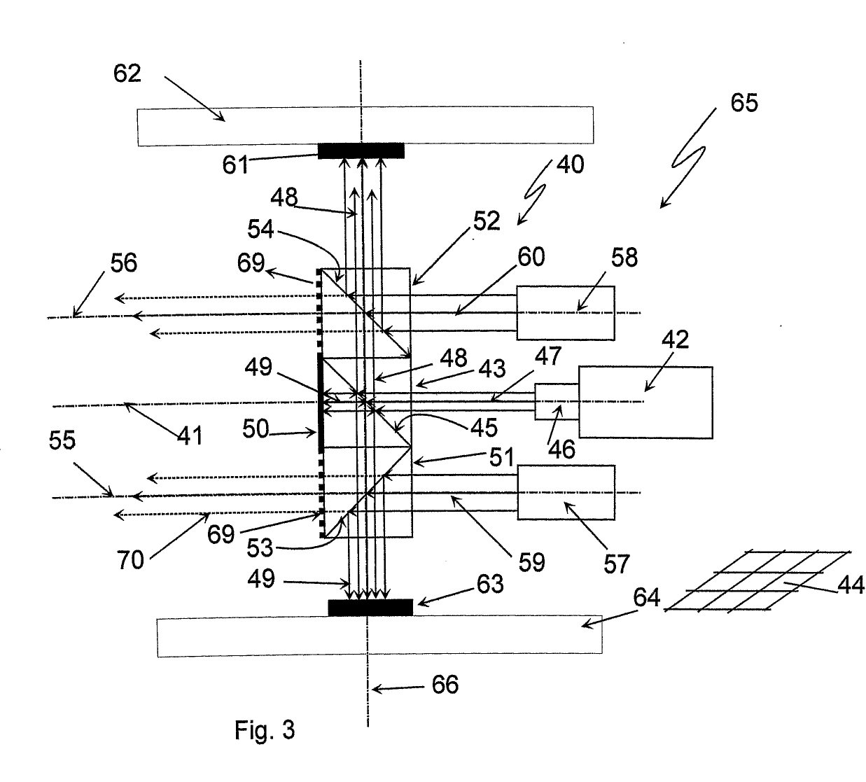

FIG. 3 shows a second optical system for observing two surface points of substrates situated one above another.

An observation device 10 implemented as an optical system, which is used for the combination with a camera unit 11, is shown in FIGS. 1 and 2. For this purpose, an input prism 13, which divides a beam path 15 exiting from an objective unit 14 of the camera unit 11 at two external boundary faces 16, 17 of the input prism 13, which are situated perpendicular to one another and are each angled at 45° to the optical axis 12, into a first and a second partial beam path 18 and 19, is situated on an optical axis 12 of the camera unit 11.

The partial beam paths 18 and 19 are oriented transversely and opposite to one another to the beam path 15 exiting from the objective unit 14 of the camera unit 11 and are each incident on an output prism 20, 21 of the observation device 10. The output prisms 20, 21 are used for deflecting the partial beam paths 18 and 19, respectively, into object beam paths 22, 23 exiting perpendicularly upward out of the plane of the drawing. For this purpose, the output prisms 20, 21 each have an optical boundary face 24, 25, which are angled by an angle of 45° to an optical plane 28 (FIG. 2) around a prism axis 26, 27 running parallel to the optical axis 12.

Illumination units, implemented here as LEDs 29, 30, are each located distal to the output prisms 20, 21 perpendicular to the optical axis 12, which emit an illumination beam path 31 and 32, respectively, which penetrates the boundary face 24 or 25, respectively, of the output prisms 20, 21, which are optically transparent in the direction of the illumination beam path 31 or 32, respectively, and, together with the particular object beam path 22 or 23, respectively, as shown in FIG. 2, allow illumination of an object surface, here formed by a terminal surface 33 or 34, respectively, of a microelectronic substrate 35, such as a chip.

As indicated by the double arrows 36 in FIGS. 1 and 2, an output prism 20, 21 and the assigned LED 31 or 32, respectively, may each be assembled in an actuating unit 37, 38 and have their distance to the optical axis 12 changed as a function of the distance of the terminal surfaces 33, 34 of the substrate. Preferably, the actuating units 37, 38 are adjusted in relation to the optical axis 12 using identical adjustment amounts and/or even simultaneously, so that a focusing optic interposed in the partial beam path 18 and/or 19 may be dispensed with.

FIG. 3 shows an observation device 40 implemented as an optical system, which has a camera unit 42 and an input prism 43 situated on an optical axis 41. The input prism 43 has an internal optical boundary face 45 angled at 45° to the optical axis 41 and situated perpendicular to an optical plane 44 which corresponds to the plane of the drawing in the present case. A beam path 47 originating from an objective unit 46 of the camera unit 42 is reflected in a first partial beam path at the boundary face 45 and deflected upward. A second partial beam path 49 penetrates the boundary face 45 and is reflected on a mirrored external boundary face 50 of the input prism 43 backward toward the boundary face 45, which has a totally reflecting action in this direction, and deflected downward thereon.

An output prism 51, 52, each of which has an optical boundary face 53, 54, is situated on each side next to the input prism 43 in the direction of the partial beam paths 48, 49. The boundary face 53 of the output prism 51 is angled at an angle of 45° in relation to a prism axis 55 running parallel to the optical axis 41 and is situated perpendicularly in relation to the optical plane 44. The boundary face 54 of the output prism 52 is angled at an angle of 45° in relation to a prism axis 56 parallel to the optical axis 41 and is situated perpendicularly in relation to the optical plane 44.

As FIG. 3 also shows, an illumination unit, implemented here as an LED 57 or 58, respectively, is assigned to both the output prism 51 and also the output prism 52, each of which emits an illumination beam path 59, 60.

The boundary face 54 of the output prism 52 is implemented as transparent to the partial beam path 48, which becomes an object beam path at the boundary face 54. The illumination beam path 60 of the assigned LED 58 is reflected axis-parallel to the partial beam path 48 at the boundary face 54 and is incident together with the partial beam path 48 on a first object face 61 of a first substrate 62 situated above the output prism 52.

The boundary face 53 of the output prism 51 is implemented as transparent for the partial beam path 49 reflected downward in the input prism 43, which becomes the object beam path at the boundary face 53. The illumination beam path 59 of the assigned LED 57 is reflected downward axis-parallel to the partial beam path 49 at the boundary face 53, so that the partial beam path 49 and the illumination beam path 59 are incident on an object face of a second substrate 54, formed here by a further terminal surface 63, situated below the output prism 51.

It is clear from the system illustrated in FIG. 3 that the observation device 40 inserted into a contact gap 65 of two substrates 62, 63 allows the correct orientation of two terminal surfaces 61, 63 which are to be contacted with one other to be checked and/or the orientation of the terminal surfaces 61, 63 to be caused as a function of a known positional deviation to achieve positioning on a contact axis 66 which corresponds to the axis of the partial beam path 49, 48.

As also shown in FIG. 3, the possibility exists of providing the output prisms 51, 52 on their rear, external boundary faces 67, 68 with an absorbent coating 69 in order to prevent scattered light from exiting.

1. An optical system (10, 40) for observing multiple objects (33, 34; 61, 63) situated distal from one another, having a camera unit (11, 42) comprising a first prism unit (13, 43), which is situated on the optical axis (12, 41) and/or in the beam path (15, 47) of the camera unit, for producing two partial beam paths (18, 19; 48, 49), as well as two object prism units (20, 21; 51, 52), each of which is situated in a partial beam path and assigned to an object.

2. The optical system according to claim 1,
characterized in that
an illumination unit (29, 30; 57, 58) is assigned to each object prism unit (20, 21; 51, 52).

3. The optical system according to claim 2,
characterized in that
the illumination units (29, 30; 57, 58) are implemented as light-emitting semiconductor components.

4. The optical system according to claim 3,
characterized in that
the illumination units are implemented as light-emitting diodes.

5. The optical system according to claim 1,
characterized in that
the output beam paths (22, 23) of the object prism units (20, 21) run transversely to and in the same direction as the optical axis (12) of the camera unit (11).

6. The optical system according to claim 5,
characterized in that
illumination beam paths (31, 32) implemented between the object prism units (20, 21) and the illumination units (29, 30) run transversely to the optical axis (12) of the camera unit (11).

7. The optical system according to claim 5,
characterized in that
the prism unit (13) has two optical boundary faces (16, 17), which are situated perpendicular to one another and are each angled at 45° to the optical axis (12) of the camera unit (11).

8. The optical system according to claim 5,
characterized in that
the object prism units (20, 21) may have their distance changed.

9. The optical system according to claim 5,
characterized in that
the illumination units (29, 30) may have their distance changed together with the object prism units (20, 21).

10. The optical system according to claim 1,
characterized in that
the output beam paths (48, 49) of the object prism units (51, 52) run transversely and in the opposite direction to the optical axis (41) of the camera unit (42).

11. The optical system according to claim 10,
characterized in that
the illumination beam paths (59, 60) implemented between the object prism units (51, 52) and the illumination units (57, 58) run parallel to the optical axis (41) of the camera unit (42).

12. The optical system according to claim 11,
characterized in that
the prism unit (43) has a first optical boundary face (45), which on the optical axis (41) of the camera unit (42) reflects a first partial beam path (48) in the direction of the first object (61) and is transparent to a second beam path (49), and which is angled by 45° to the optical axis, a second optical boundary face (50) situated perpendicular to the optical axis being positioned downstream from said first optical boundary face for reflecting the second partial beam path toward the first optical boundary face and reflecting the second partial beam path in the direction of the second object (63).
